(19) United States
(12) Patent Application Publication
(10) Pub. No.: US 2026/0217078 A1
(43) Pub. Date: Jul. 30, 2026

(54) SUSPENSION SYSTEM

(71) Applicant: AISIN CORPORATION, Kariya, Aichi (JP)

(72) Inventor: Akihito YAMAMOTO, Kariya-shi, Aichi-ken (JP)

(73) Assignee: AISIN CORPORATION, Kariya, Aichi (JP)

(21) Appl. No.: 19/145,374

(22) PCT Filed: Jan. 24, 2024
(86) PCT No.: PCT/JP2024/002043

§ 371 Date: Jul. 2, 2025

(30) Foreign Application Priority Data
Mar. 24, 2023 (JP) 2023-047536

(51) Int. Cl. B60G 17/0185; B60G 17/06

(52) U.S. Cl. CPC B60G 17/0185; B60G 17/06; B60G 2400/102; B60G 2400/252; B60G 2400/60; B60G 2600/042; B60G 2600/08

(57) ABSTRACT

A suspension system of an embodiment includes: an estimation unit configured to use a trained model to estimate, from input information including a measured value of sprung acceleration, either or both of a stroke displacement amount indicating an amount of displacement of a shock absorber and a stroke velocity indicating a displacement velocity of the shock absorber; a calculation unit configured to calculate an estimated value of the sprung acceleration based on the estimation result from the estimation unit; and an abnormality determination unit configured to determine the presence or absence of an abnormality based on an error between the measured value of the sprung acceleration and the estimated value of the sprung acceleration.

### CROSS REFERENCE TO RELATED APPLICATIONS

This application is a National Stage of International Application No. PCT/JP2024/002043 filed Jan. 24, 2024, claiming priority based on Japanese Patent Application No. 2023-047536 filed Mar. 24, 2023.

### TECHNICAL FIELD

An embodiment of the present disclosure relates to a suspension system.

### BACKGROUND ART

In suspension systems that can adjust, according to the situation, a damping force for causing vibration (expansion and contraction motion) of a spring that reduces impact from the road surface to a vehicle body to converge, a trained model (artificial intelligence) is sometimes used to control the damping force.

### RELATED ART DOCUMENTS

### Patent Documents

Patent Document 1: WO 2022/024919
Patent Document 2: WO2021/064833

### SUMMARY OF THE DISCLOSURE

### Problem to be Solved by Various Aspects of the Disclosure

A system like the one described above is desired to have a function to detect occurrence of an abnormality, in view of the possibility that processing using a trained model may lose its appropriateness.

One of issues that embodiments of the present disclosure aim to resolve is to allow detection of an abnormality in a suspension system that adjusts a damping force using a trained model.

### Means for Solving the Problem

One embodiment of the present disclosure is a suspension system that includes a shock absorber configured to generate a damping force for causing vibration of a spring interposed between a wheel and a vehicle body to converge and that is configured to adjust the damping force. The suspension system includes: an estimation unit configured to use a trained model to estimate, from input information including a measured value of sprung acceleration, either or both of a stroke displacement amount indicating an amount of displacement of the shock absorber and a stroke velocity indicating a displacement velocity of the shock absorber; a calculation unit configured to calculate an estimated value of the sprung acceleration based on the estimation result from the estimation unit; and an abnormality determination unit configured to determine the presence or absence of an abnormality based on an error between the measured value of the sprung acceleration and the estimated value of the sprung acceleration.

### Effects of Various Aspects of the Disclosure

In the control device according to the embodiment of the present disclosure, an estimated value of the sprung acceleration is calculated based on either or both the stroke displacement amount and the stroke velocity as estimated by the trained model from the input information including a measured value of the sprung acceleration, and an abnormality is determined based on the error between the measured value and the estimated value of the sprung acceleration. This allows an abnormality in the system that performs control using the trained model to be detected with high accuracy, which can improve the reliability of the system.

### BRIEF DESCRIPTION OF THE DRAWINGS

FIG. 1 is a diagram showing an example of the configuration of a suspension system mounted on a vehicle of a first embodiment.

FIG. 2 is a diagram showing an example of the configuration of a suspension device of the first embodiment.

FIG. 3 is a diagram showing an example of a functional configuration of an ECU of the first embodiment.

FIG. 4 is a diagram illustrating an example of a method for calculating estimated sprung acceleration in the first embodiment.

FIG. 5 is a diagram showing an example of the relationship among sprung acceleration, an error, and an abnormality determination flag when an abnormality occurs in the first embodiment.

FIG. 6 is a flowchart showing an example of a process that is performed by the ECU of the first embodiment.

FIG. 7 is a diagram showing an example of a functional configuration of an ECU of a second embodiment.

FIG. 8 is a diagram illustrating an example of a method for calculating estimated sprung acceleration in the second embodiment.

FIG. 9 is a flowchart showing an example of a process that is performed by the ECU of the second embodiment.

FIG. 10 is a diagram showing an example of a functional configuration of an ECU of a third embodiment.

FIG. 11 is a diagram illustrating an example of a method for calculating estimated sprung acceleration in the third embodiment.

FIG. 12 is a flowchart showing an example of a process that is performed by the ECU of the third embodiment.

### MODES FOR CARRYING OUT THE DISCLOSURE

Illustrative embodiments of the present disclosure will be disclosed below. The configurations of the embodiments described below and the functions, results, and effects provided by the configurations are illustrative. The present disclosure can be implemented by configurations other than those disclosed in the following embodiments, and it is possible to obtain at least one of various effects based on the basic configuration and derivative effects.

### First Embodiment

FIG. 1 is a diagram showing an example of the configuration of a suspension system S mounted on a vehicle 1 of a first embodiment. The vehicle 1 illustrated herein is a four-wheeled automobile that can travel on a road surface, and includes a vehicle body 2 and four wheels 3.

The suspension system S includes a suspension device 11, an acceleration sensor 12, and an ECU (Electronic Control Unit) 13.

The suspension device 11 is a device that is installed between each of the four wheels 3 and the vehicle body 2 and that serves to reduce impact from the road surface to the vehicle body 2.

The acceleration sensor 12 is a sensor that is installed on top of each of the four suspension devices 11 and that detects sprung acceleration corresponding to its installation position. The sprung acceleration is the acceleration of displacement in an up-down direction of a portion above the suspension device 11 (mainly the vehicle body 2). The number and installation positions of acceleration sensors 12 are not limited to those described above.

The ECU 13 is an information processing device that executes information processing for controlling each suspension device 11, and is communicably connected to in-vehicle devices such as the suspension devices 11 via a network such as a CAN (Controller Area Network). The ECU 13 acquires signals (analog signals) output from the acceleration sensors 12 via appropriate lines. The ECU 13 may be configured using, for example, a CPU (Central Processing Unit), a memory, an FPGA (Field Programmable Gate Array), an ASIC (Application-Specific Integrated Circuit), etc. In addition to the suspension devices 11 and the acceleration sensors 12, the in-vehicle devices connected to the ECU 13 may include, for example, wheel speed sensors that detect the rotational speeds (wheel speeds) of the wheels 3, a three-axis acceleration sensor that detects the tilt of the vehicle body 2, a steering angle sensor that detects the steering angle, and other ECUs that perform predetermined controls.

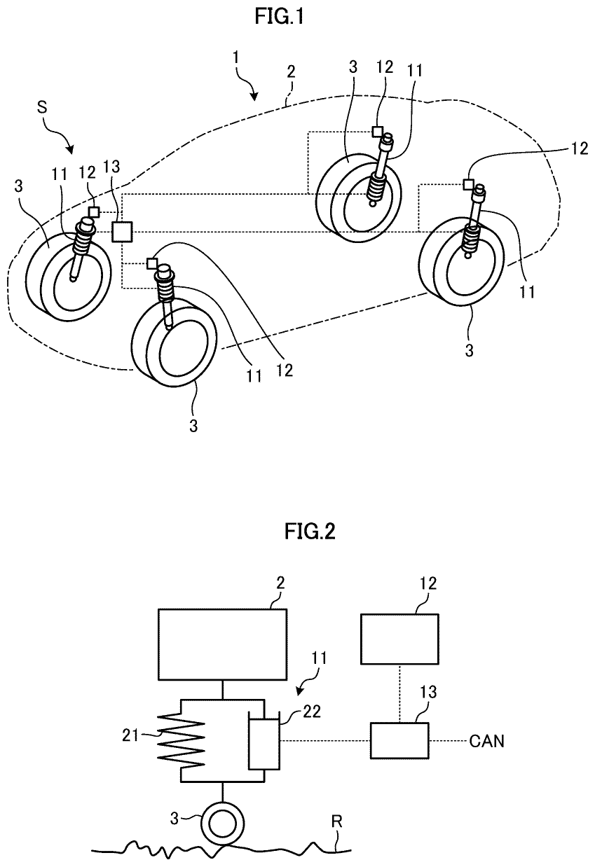

FIG. 2 is a diagram showing an example of the configuration of the suspension device 11 of the first embodiment. FIG. 2 schematically shows the configuration of one suspension device 11 interposed between one wheel 3 and the vehicle body 2. The suspension device 11 includes a spring 21 and a shock absorber 22. All of the four suspension devices 11 have the same configuration.

The spring 21 is a member that is interposed between the wheel 3 and the vehicle body 2 and that expands and contracts to absorb impact from a road surface R to the vehicle body 2. The spring 21 generates a reaction force (restoring force) according to its expansion and contraction state. Hereinafter, the reaction force according to the expansion and contraction state of the spring 21 will be referred to as spring force.

The shock absorber 22 is a unit that generates a damping force for causing vibration (expansion and contraction motion) of the spring 21 to converge. The damping force of the shock absorber 22 can be changed according to a control signal (control current) from the ECU 13. Although the specific configuration of the shock absorber 22 is not particularly limited, a configuration may be adopted that uses, for example, a hydraulic damper whose damping force changes according to the fluid pressure, an actuator that operates to change the fluid pressure of the hydraulic damper according to a control current from the ECU 13, etc.

The ECU 13 of the present embodiment performs a process of optimizing the damping force of the shock absorber 22 based on various kinds of information on the vehicle 1 acquired from the acceleration sensors 12, the CAN, etc. The various kinds of information may include the sprung accelerations acquired from the acceleration sensors 12, the wheel speeds acquired from the wheel speed sensors etc., and the longitudinal acceleration, lateral acceleration, yaw rate, etc. acquired from the three-axis acceleration sensor mounted on the vehicle body 2 etc. Although the specific method for controlling the damping force by the ECU 13 is not particularly limited, control based on, for example, the skyhook theory may be used.

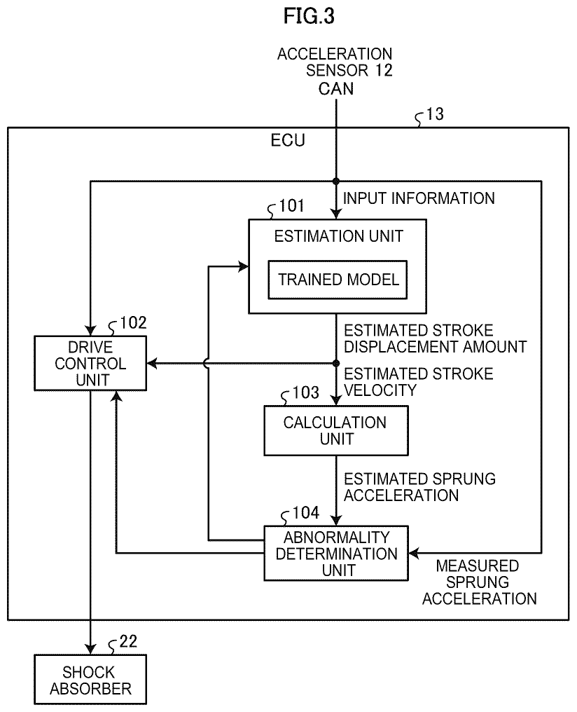

FIG. 3 is a diagram showing an example of a functional configuration of the ECU 13 of the first embodiment. The ECU 13 of the present embodiment includes an estimation unit 101, a drive control unit 102, a calculation unit 103, and an abnormality determination unit 104. These functional units 101 to 104 can be configured through collaboration of hardware elements and software elements (programs etc.) of the ECU 13. At least one of these functional units 101 to 104 may be configured by dedicated hardware (circuit etc.).

The estimation unit 101 estimates the stroke displacement amount and stroke velocity of the shock absorber 22 from predetermined input information by using a trained model. The stroke displacement amount is the amount of displacement of the shock absorber 22 in the up-down direction. The stroke velocity is the displacement velocity of the shock absorber 22 in the up-down direction. The input information includes at least measured sprung acceleration that is a measured value of the spring receiving acceleration detected by the acceleration sensor 12. The input information may further include the wheel speed, the longitudinal acceleration, the lateral acceleration, the yaw rate, and other information.

The trained model is a model generated by machine learning (deep learning) performed in advance using predetermined training data for a neural network. The trained model may be a predetermined algorithm to which parameters (weights) determined by the machine learning have been applied, etc. The parameters of the trained model may include parameters that are updated through use (as the vehicle 1 travels). The trained model of the present embodiment outputs an estimated stroke displacement amount that is an estimated value of the stroke displacement amount and an estimated stroke velocity that is an estimated value of the stroke velocity, in response to input of the input information including the measured sprung acceleration. Although the specific form of the trained model is not particularly limited, a model having, for example, an RNN (Recurrent Neural Network) structure or an LSTM (Long Short Term Memory) structure may be adopted.

The drive control unit 102 determines a target value of the damping force of the shock absorber 22 based on the information acquired from the acceleration sensor 12 and the CAN, the estimation results from the estimation unit 101, etc., and outputs a control signal (control current) to the shock absorber 22 such that the damping force of the shock absorber 22 becomes the target value. Although the method for determining the target value of the damping force is not particularly limited, a method based on, for example, the skyhook theory may be used.

The calculation unit 103 calculates estimated sprung acceleration that is an estimated value of the sprung acceleration, based on the estimation results from the estimation unit 101, i.e., the estimated stroke displacement amount and estimated stroke velocity output from the trained model. The method for calculating the estimated sprung acceleration from the estimated stroke displacement amount and the estimated stroke velocity may be implemented using a known calculation method as appropriate. For example, an estimated spring force that is an estimated value of the spring force of the spring 21 can be calculated from the estimated stroke displacement amount, an estimated damping force that is an estimated value of the damping force of the shock absorber 22 can be calculated from the estimated stroke velocity, and the estimated sprung acceleration can be calculated from the estimated spring force and the estimated damping force based on an equation of motion etc.

The abnormality determination unit 104 determines the presence or absence of an abnormality based on the error between the measured sprung acceleration acquired from the acceleration sensor 12 and the estimated sprung acceleration calculated by the calculation unit 103. For example, when this error is greater than or equal to a threshold, the abnormality determination unit 104 determines that there is an abnormality.

The abnormality determination unit 104 may perform a predetermined abnormality handling process when it determines that there is an abnormality. The abnormality handling process may be, for example, resetting the parameters in the trained model. The parameters to be reset are, for example, parameters that are updated through use (as the vehicle 1 travels), and may be, for example, stored values in an RNN, an LSTM, etc. This may be able to normalize the operation of the trained model. The abnormality handling process may be, for example, a process of prohibiting the use of the estimation results from the estimation unit 101 in controlling the damping force of the shock absorber 22. This can avoid the damping force being controlled based on inappropriate estimation results.

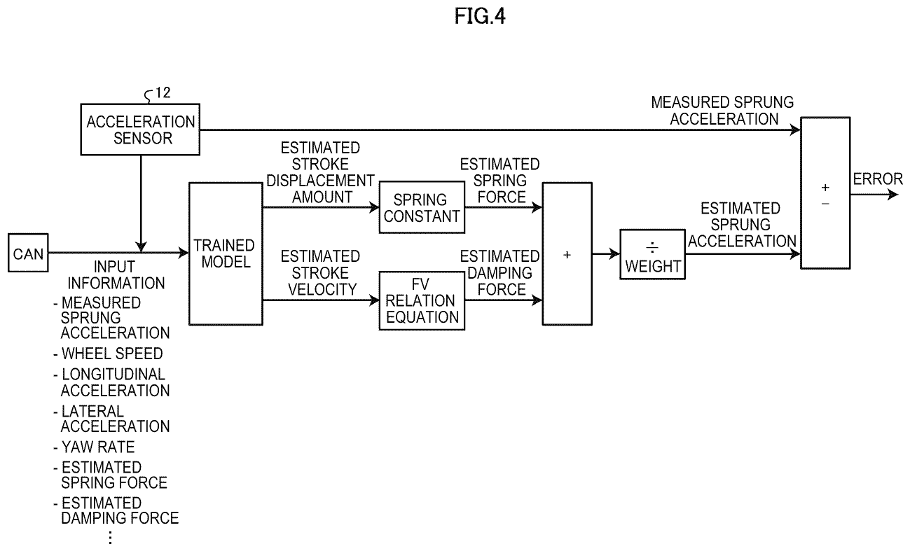

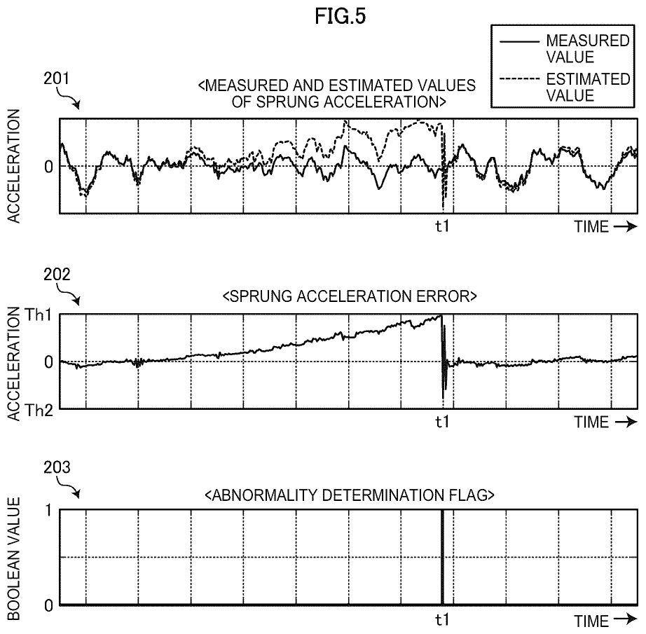

FIG. 4 is a diagram illustrating an example of a method for calculating estimated sprung acceleration in the first embodiment. As shown in FIG. 4, when input information including measured sprung acceleration acquired from the acceleration sensor 12 is input to the trained model of the present embodiment, the trained model outputs an estimated stroke displacement amount and an estimated stroke velocity. The input information may include, in addition to the measured sprung acceleration, a wheel speed, longitudinal acceleration, lateral acceleration, a yaw rate, a feedback value of an estimated spring force, a feedback value of an estimated damping force, etc. Including information other than the measured sprung acceleration in the input information as described above can improve the estimation accuracy of the trained model.

An estimated spring force is calculated by multiplying the estimated stroke displacement amount output from the trained model by the spring constant of the spring 21. An estimated damping force that is a damping force corresponding to the estimated stroke velocity output from the trained model is calculated using an FV (Forth-Velocity) relation equation representing the correspondence between the stroke velocity and the damping force. For example, the FV relation equation may be generated based on experiments or simulations conducted in advance, or may be generated based on information acquired during traveling. The estimated spring force and estimated damping force calculated in this manner may be fed back as input information to the trained model.

The estimated spring force and estimated damping force calculated as above are added together, and the sum is divided by the sprung weight (e.g., the weight of the vehicle body 2 etc.) to calculate estimated sprung acceleration. The presence or absence of an abnormality is determined based on the error between the measured sprung acceleration and the estimated sprung acceleration.

It should be noted that the above calculation method is illustrative, and the method for calculating estimated sprung acceleration in the present embodiment is not limited to this.

FIG. 5 is a diagram showing an example of the relationship among sprung acceleration, an error, and an abnormality determination flag when an abnormality occurs in the first embodiment. FIG. 5 illustrates the correspondence between sprung acceleration change information 201, error change information 202, and flag change information 203.

The sprung acceleration change information 201 illustrates time-series changes in the measured value (measured sprung acceleration) and estimated value (estimated sprung acceleration) of the sprung acceleration. The error change information 202 illustrates time-series changes in the error between the measured value and the estimated value of the sprung acceleration (estimated value-measured value). Th1 indicates a threshold on the positive side, and Th2 indicates a threshold on the negative side. The flag change information 203 illustrates time-series changes in the value (boolean value) of a flag indicating the presence or absence of an abnormality. In this example, the flag value is “0” under normal conditions and the flag value is “1” when an abnormality occurs. It is herein assumed that the time axes (horizontal axes) of the sprung acceleration change information 201, the error change information 202, and the flag change information 203 are aligned.

FIG. 5 illustrates an example in which the measured value and the estimated value of the sprung acceleration gradually diverge as time progresses, and the error reaches the threshold Th1 at time t1. In such a case, the flag value becomes 1 at time t1, and the abnormality handling process is performed. As a result, as shown in FIG. 5, the deviation (error) between the measured value and the estimated value of the sprung acceleration is substantially eliminated after time t1, and the flag value becomes 0.

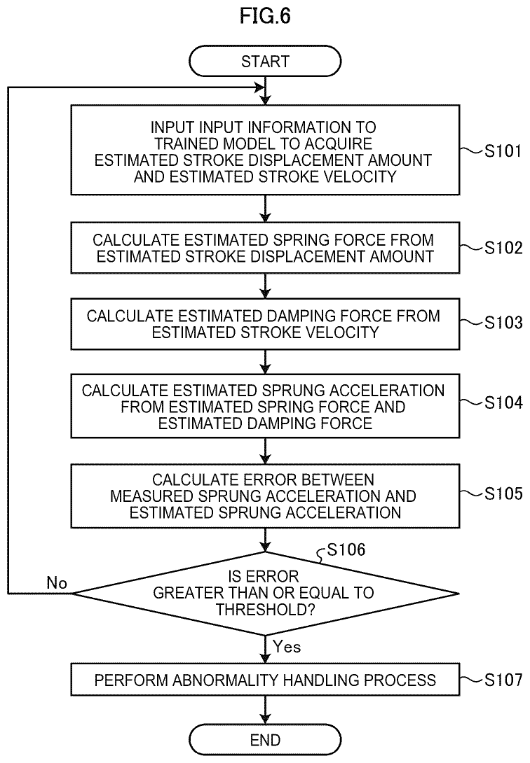

FIG. 6 is a flowchart showing an example of a process that is performed by the ECU 13 of the first embodiment. The estimation unit 101 inputs input information to the trained model to acquire an estimated stroke displacement amount and an estimated stroke velocity (S101). The calculation unit 103 calculates an estimated spring force from the estimated stroke displacement amount (S102), calculates an estimated damping force from the estimated stroke velocity (S103), and calculates estimated sprung acceleration from the estimated spring force and the estimated damping force (S104).

The abnormality determination unit 104 calculates an error between the measured sprung acceleration and the estimated sprung acceleration (S105), and determines whether the error is greater than or equal to the threshold (S106). When the error is not greater than or equal to the threshold (S106: No), step S101 and the subsequent steps are performed again. When the error is greater than or equal to the threshold (S106: Yes), the abnormality determination unit 104 performs the abnormality handling process such as resetting the parameters in the trained model (S107).

As described above, according to the present embodiment, an estimated value of the sprung acceleration is calculated based on the stroke displacement amount and the stroke velocity as estimated by the trained model from the input information including a measured value of the sprung acceleration, and an abnormality is determined based on the error between the measured value and the estimated value of the sprung acceleration. This allows an abnormality in the suspension system S that performs control using the trained model to be detected with high accuracy, which can improve the reliability of this system.

Other embodiments will be described below. However, description of those parts that have the same or similar effects as in the first embodiment will be omitted as appropriate.

### Second Embodiment

The trained model of the first embodiment outputs an estimated stroke displacement amount and an estimated stroke velocity in response to input of input information. However, a trained model of the second embodiment outputs an estimated stroke displacement amount but does not output an estimated stroke velocity in response to input of input information.

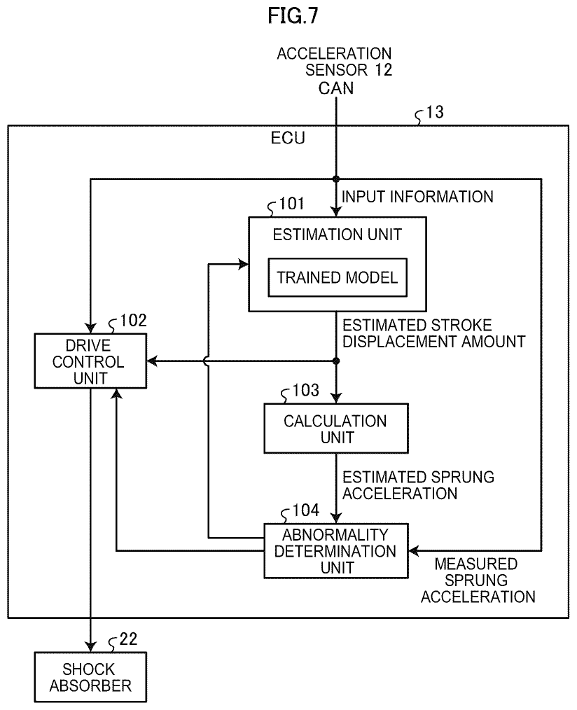

FIG. 7 is a diagram showing an example of a functional configuration of the ECU 13 of the second embodiment. The estimation unit 101 of the present embodiment uses such a trained model as described above to acquire an estimated value of the stroke displacement amount (estimated stroke displacement amount) from input information including measured sprung acceleration. The calculation unit 103 of the present embodiment calculates an estimated value of the sprung acceleration (estimated sprung acceleration) based on the estimated stroke displacement amount as estimated by the estimation unit 101.

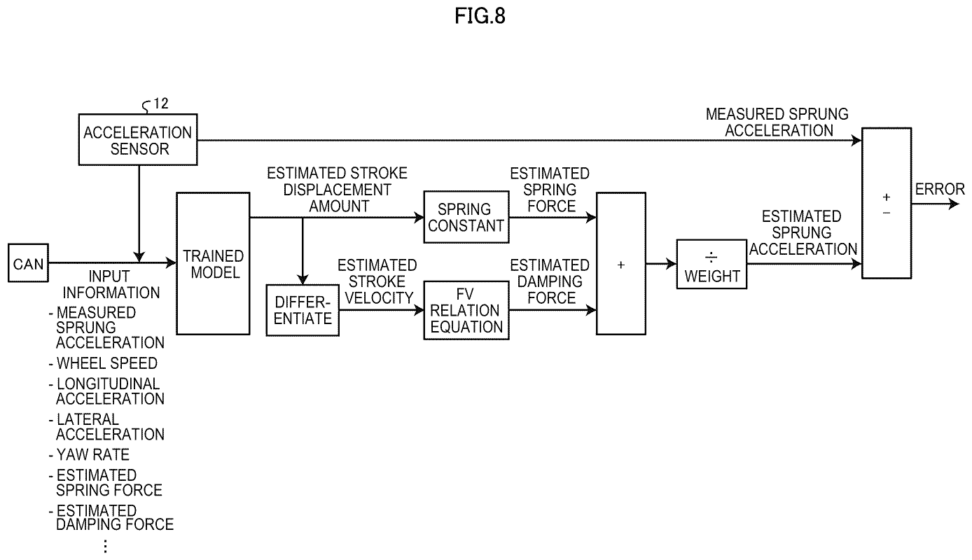

FIG. 8 is a diagram illustrating an example of a method for calculating estimated sprung acceleration in the second embodiment. As shown in FIG. 8, when input information including measured sprung acceleration acquired from the acceleration sensor 12 is input to the trained model of the present embodiment, the trained model outputs an estimated stroke displacement amount. In the present embodiment, an estimated stroke velocity is calculated by differentiating the estimated stroke displacement amount output from the trained model.

The subsequent processing, i.e., calculation of an estimated spring force, an estimated damping force, and estimated sprung acceleration, is performed in the same manner as in the first embodiment. That is, an estimated spring force is calculated by multiplying the estimated stroke displacement amount output from the trained model by the spring constant of the spring 21, and an estimated damping force corresponding to the estimated stroke velocity is calculated using a predetermined FV relation equation. Estimated sprung acceleration is calculated based on the estimated spring force and the estimated damping force.

It should be noted that the above calculation method is illustrative, and the method for calculating estimated sprung acceleration in the present embodiment is not limited to this.

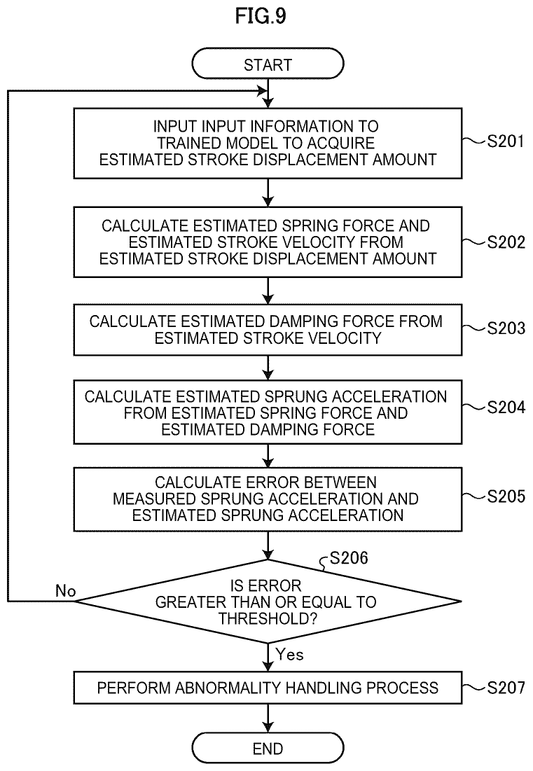

FIG. 9 is a flowchart showing an example of a process that is performed by the ECU 13 of the second embodiment. The estimation unit 101 inputs input information to the trained model to acquire an estimated stroke displacement amount (S201). The calculation unit 103 calculates an estimated spring force and an estimated stroke velocity from the estimated stroke displacement amount (S202), calculates an estimated damping force from the estimated stroke velocity (S203), and calculates estimated sprung acceleration from the estimated spring force and the estimated damping force (S204).

The abnormality determination unit 104 calculates an error between the measured sprung acceleration and the estimated sprung acceleration (S205), and determines whether the error is greater than or equal to the threshold (S206). When the error is not greater than or equal to the threshold (S206: No), step S201 and the subsequent steps are performed again. When the error is greater than or equal to the threshold (S206: Yes), the abnormality determination unit 104 performs the abnormality handling process such as resetting the parameters in the trained model (S207).

As described above, according to the present embodiment, even when a trained model is used that outputs an estimated stroke displacement amount (and does not output an estimated stroke velocity) in response to input information including a measured value of sprung acceleration, an abnormality in the system can be detected and the reliability of the system can be improved, as in the first embodiment.

### Third Embodiment

The trained model of the first embodiment outputs an estimated stroke displacement amount and an estimated stroke velocity in response to input of input information. However, a trained model of the third embodiment outputs an estimated stroke velocity but does not output an estimated stroke displacement amount in response to input of input information.

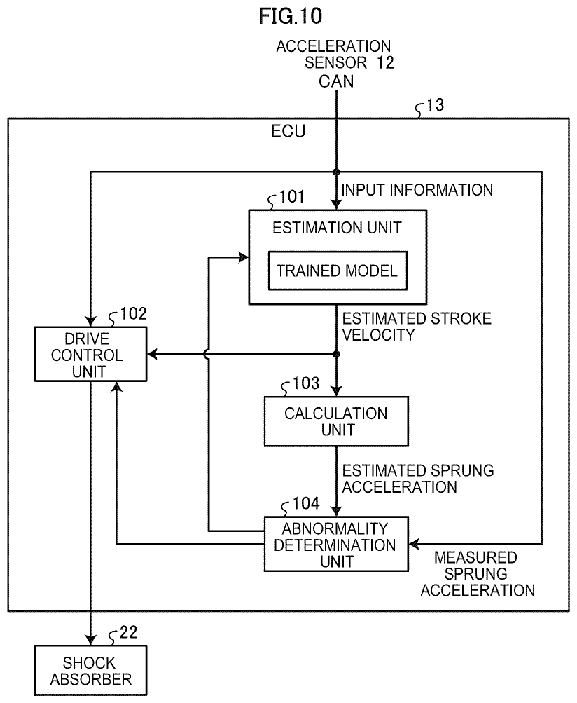

FIG. 10 is a diagram showing an example of a functional configuration of the ECU 13 of the third embodiment. The estimation unit 101 of the present embodiment uses such a trained model as described above to acquire an estimated value of the stroke velocity (estimated stroke velocity) from input information including measured sprung acceleration. The calculation unit 103 of the present embodiment calculates an estimated value of the sprung acceleration (estimated sprung acceleration) based on the estimated stroke velocity as estimated by the estimation unit 101.

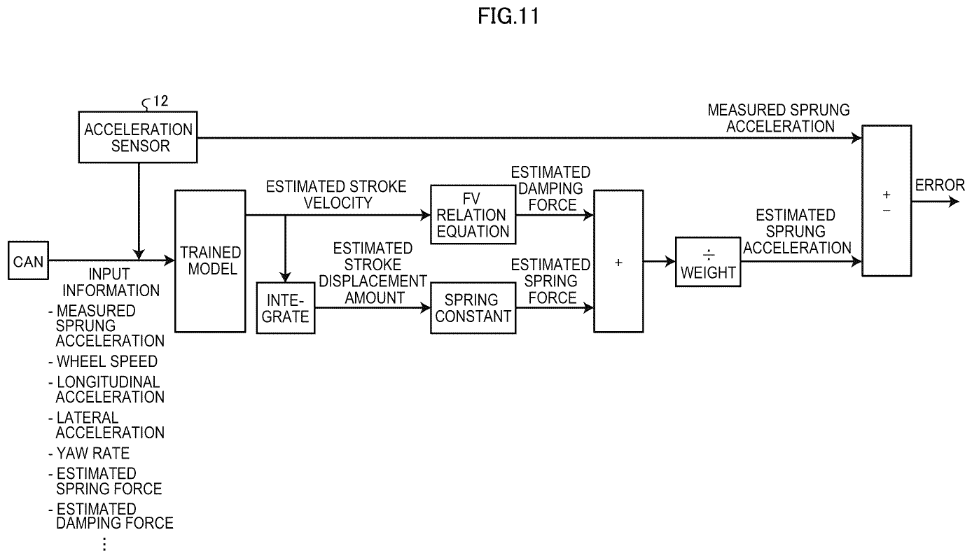

FIG. 11 is a diagram illustrating an example of a method for calculating estimated sprung acceleration in the third embodiment. As shown in FIG. 11, when input information including measured sprung acceleration acquired from the acceleration sensor 12 is input to the trained model of the present embodiment, the trained model outputs an estimated stroke velocity. In the present embodiment, an estimated stroke displacement amount is calculated by integrating the estimated stroke velocity output from the trained model.

The subsequent processing, i.e., calculation of an estimated spring force, an estimated damping force, and estimated sprung acceleration, is performed in the same manner as in the first embodiment. That is, an estimated spring force is calculated by multiplying the estimated stroke displacement amount calculated as described above by the spring constant of the spring 21, and an estimated damping force corresponding to the estimated stroke velocity is calculated using a predetermined FV relation equation. Estimated sprung acceleration is calculated based on the estimated spring force and the estimated damping force.

It should be noted that the above calculation method is illustrative, and the method for calculating estimated sprung acceleration in the present embodiment is not limited to this.

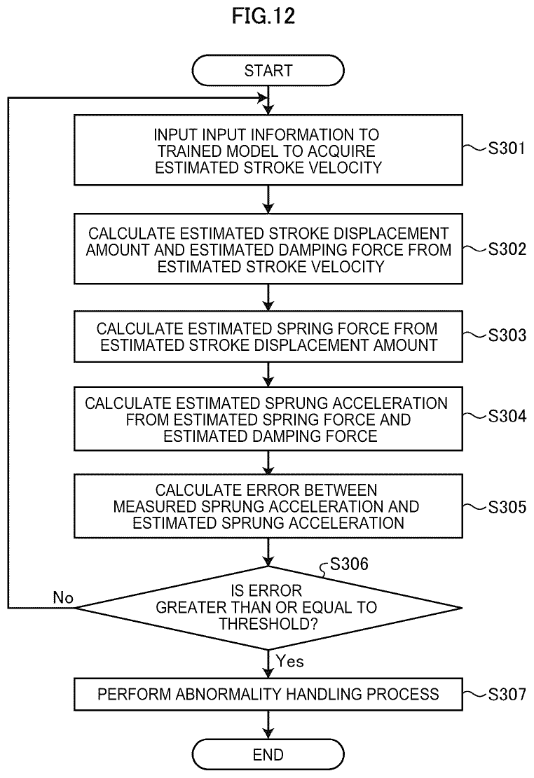

FIG. 12 is a flowchart showing an example of a process that is performed by the ECU 13 of the third embodiment. The estimation unit 101 inputs input information to the trained model to acquire an estimated stroke velocity (S301). The calculation unit 103 calculates an estimated stroke displacement amount and an estimated damping force from the estimated stroke velocity (S302), calculates an estimated spring force from the estimated stroke displacement amount (S303), and calculates estimated sprung acceleration from the estimated spring force and the estimated damping force (S304).

The abnormality determination unit 104 calculates an error between the measured sprung acceleration and the estimated sprung acceleration (S305), and determines whether the error is greater than or equal to the threshold (S306). When the error is not greater than or equal to the threshold (S306: No), step S301 and the subsequent steps are performed again. When the error is greater than or equal to the threshold (S306: Yes), the abnormality determination unit 104 performs the abnormality handling process such as resetting the parameters in the trained model (S307).

As described above, according to the present embodiment, even when a trained model is used that outputs an estimated stroke velocity (and does not output an estimated stroke displacement amount) in response to input information including a measured value of sprung acceleration, an abnormality in the system can be detected and the reliability of the system can be improved, as in the first embodiment.

A program for causing a computer (e.g., the ECU 14 etc.) to implement the functions of the suspension system S of the above embodiments may be configured to be provided by being recorded on a computer-readable recording medium such as a CD-ROM, a flexible disk (FD), a CD-R, or a DVD (Digital Versatile Disk) as a file in an installable or executable format.

This program may be configured to be stored on a computer connected to a network such as the Internet and provided by being downloaded via the network. This program may also be configured to be provided or distributed via a network such as the Internet.

Although several embodiments of the present disclosure have been described, these embodiments are presented by way of example and are not intended to limit the scope of the disclosure. These novel embodiments can be carried out in various other forms, and various omissions, replacements, and changes can be made without departing from the spirit and scope of the disclosure. These embodiments and their modifications are included in the spirit and scope of the disclosure, and are included in the scope of the disclosure described in the claims and equivalents thereof.

### Summary of Embodiments

The suspension system(S) of the embodiments include at least the following configurations. That is, the suspension system(S) is a suspension system(S) that includes a shock absorber (22) configured to generate a damping force for causing vibration of a spring (21) interposed between a wheel (3) and a vehicle body (2) to converge, and that is configured to adjust the damping force. The suspension system(S) includes: an estimation unit (101) configured to use a trained model to estimate, from input information including a measured value of sprung acceleration, either or both of a stroke displacement amount indicating an amount of displacement of the shock absorber (22) and a stroke velocity indicating a displacement velocity of the shock absorber (22); a calculation unit (103) configured to calculate an estimated value of the sprung acceleration based on the estimation result from the estimation unit (101); and an abnormality determination unit (104) configured to determine the presence or absence of an abnormality based on an error between the measured value of the sprung acceleration and the estimated value of the sprung acceleration.

With this configuration, an estimated value of the sprung acceleration is calculated based on either or both of the stroke displacement amount and the stroke velocity as estimated by the trained model from the input information including a measured value of the sprung acceleration, and an abnormality is determined based on the error between the measured value and the estimated value of the sprung acceleration. This allows an abnormality in the system that performs control using the trained model to be detected with high accuracy, which can improve the reliability of the system.

In the suspension system(S), it is preferable that, when the estimation unit (101) estimates the stroke displacement amount and the stroke velocity, the calculation unit (103) calculate, based on an estimated value of the stroke displacement amount as estimated by the estimation unit (101), an estimated value of a spring force that is a reaction force generated by the spring (21), calculate an estimated value of the damping force based on an estimated value of the stroke velocity as estimated by the estimation unit (101), and calculate the estimated value of the sprung acceleration based on the estimated value of the spring force and the estimated value of the damping force.

With this configuration, the estimated value of the sprung acceleration can be efficiently calculated based on the stroke displacement amount and the stroke velocity as estimated by the trained model.

In the suspension system(S), it is preferable that, when the estimation unit (101) estimates the stroke displacement amount, the calculation unit (103) calculate, based on an estimated value of the stroke displacement amount as estimated by the estimation unit (101), an estimated value of a spring force that is a reaction force generated by the spring (21) and an estimated value of the stroke velocity indicating the displacement velocity of the shock absorber (22), calculate an estimated value of the damping force based on the estimated value of the stroke velocity, and calculate the estimated value of the sprung acceleration based on the estimated value of the spring force and the estimated value of the damping force.

With this configuration, the estimated value of the sprung acceleration can be efficiently calculated based on the stroke displacement amount estimated by the trained model.

In the suspension system(S), it is preferable that, when the estimation unit (101) estimates the stroke velocity, the calculation unit (103) calculate an estimated value of the stroke displacement amount and an estimated value of the damping force based on an estimated value of the stroke velocity as estimated by the estimation unit (101), calculate, based on the estimated value of the stroke displacement amount, an estimated value of a spring force that is a reaction force generated by the spring (21), and calculate the estimated value of the sprung acceleration based on the estimated value of the spring force and the estimated value of the damping force.

With this configuration, the estimated value of the sprung acceleration can be efficiently calculated based on the stroke velocity estimated by the trained model.

In the suspension system(S), it is preferable that, when the abnormality determination unit (104) determines that there is the abnormality, the abnormality determination unit reset a parameter in the trained model.

This configuration can normalize the function of the trained model.

In the above configuration, it is preferable that, when the abnormality determination unit (104) determines that there is the abnormality, the abnormality determination unit prohibit the use of the estimation result from the estimation unit (101) in controlling the damping force.

This configuration can avoid control being performed based on inappropriate estimation results.

### DESCRIPTION OF THE REFERENCE NUMERALS

1 vehicle, 2 . . . vehicle body, 3 . . . wheel, 11 . . . suspension device, 12 . . . acceleration sensor, 13 . . . . ECU, 21 . . . spring, 22 . . . shock absorber, 101 . . . estimation unit, 102 . . . drive control unit, 103 . . . calculation unit, 104 . . . abnormality determination unit, 201 . . . sprung acceleration change information, 202 . . . error change information, 203 . . . flag change information, R . . . road surface, S . . . suspension system

1. A suspension system including a shock absorber configured to generate a damping force for causing vibration of a spring interposed between a wheel and a vehicle body to converge, the suspension system being configured to adjust the damping force, the suspension system comprising:
an estimation unit configured to use a trained model to estimate, from input information including a measured value of sprung acceleration, either or both of a stroke displacement amount indicating an amount of displacement of the shock absorber and a stroke velocity indicating a displacement velocity of the shock absorber;
a calculation unit configured to calculate an estimated value of the sprung acceleration based on an estimation result from the estimation unit; and
an abnormality determination unit configured to determine presence or absence of an abnormality based on an error between the measured value of the sprung acceleration and the estimated value of the sprung acceleration.

2. The suspension system according to claim 1, wherein when the estimation unit estimates the stroke displacement amount and the stroke velocity, the calculation unit calculates, based on an estimated value of the stroke displacement amount as estimated by the estimation unit, an estimated value of a spring force that is a reaction force generated by the spring, calculates an estimated value of the damping force based on an estimated value of the stroke velocity as estimated by the estimation unit, and calculates the estimated value of the sprung acceleration based on the estimated value of the spring force and the estimated value of the damping force.

3. The suspension system according to claim 1, wherein when the estimation unit estimates the stroke displacement amount, the calculation unit calculates, based on an estimated value of the stroke displacement amount as estimated by the estimation unit, an estimated value of a spring force that is a reaction force generated by the spring and an estimated value of the stroke velocity indicating the displacement velocity of the shock absorber, calculates an estimated value of the damping force based on the estimated value of the stroke velocity, and calculates the estimated value of the sprung acceleration based on the estimated value of the spring force and the estimated value of the damping force.

4. The suspension system according to claim 1, wherein when the estimation unit estimates the stroke velocity, the calculation unit calculates an estimated value of the stroke displacement amount and an estimated value of the damping force based on an estimated value of the stroke velocity as estimated by the estimation unit, calculates, based on the estimated value of the stroke displacement amount, an estimated value of a spring force that is a reaction force generated by the spring, and calculates the estimated value of the sprung acceleration based on the estimated value of the spring force and the estimated value of the damping force.

5. The suspension system according to claim 1, wherein when the abnormality determination unit determines that there is the abnormality, the abnormality determination unit resets a parameter in the trained model.

6. The suspension system according to claim 1, wherein when the abnormality determination unit determines that there is the abnormality, the abnormality determination unit prohibits use of the estimation result from the estimation unit in controlling the damping force.
